(19) United States
(12) Patent Application Publication
(10) Pub. No.: US 2020/0275056 A1
(43) Pub. Date: Aug. 27, 2020

(54) VIDEO VISITATION AND CALLING USING RICH COMMUNICATION SERVICES (RCS)

(71) Applicant: Securus Technologies, Inc., Carrollton, TX (US)

(72) Inventor: Matthew Smith, McKinney, TX (US)

(73) Assignee: Securus Technologies, Inc., Carrollton, TX (US)

(21) Appl. No.: 15/911,507

(22) Filed: Mar. 5, 2018

(51) Int. Cl. H04N 7/15; H04L 29/06

(52) U.S. Cl. CPC H04N 7/15; H04L 61/1529; H04L 65/1066; H04L 65/1003

(57) ABSTRACT

Systems and methods for video visitation and calling using Rich Communication Services (RCS) are described. In some embodiments, a method may include: receiving a text message, via a native RCS client of a non-resident device operated by a non-resident of a correctional facility, indicating that a scheduled video visitation session with a resident of the correctional facility is available to be established; and establishing the scheduled video visitation session between the resident and the non-resident, at least in part, via the native RCS client.

### TECHNICAL FIELD

This specification relates generally to telecommunications, and, more particularly, to systems and methods for video visitation and calling using Rich Communication Services (RCS).

### BACKGROUND

According to the International Centre for Prison Studies, the United States has the highest prison population per capita in the world. In 2009, for example, 1 out of every 135 U.S. residents was incarcerated. Generally, inmates convicted of felony offenses serve long sentences in prison (e.g., federal or state prisons), whereas those convicted of misdemeanors receive shorter sentences to be served in jail (e.g., county jail). In either case, while awaiting trial, a suspect or accused may remain incarcerated. During his or her incarceration, an inmate may have opportunities to communicate with the outside world.

By allowing prisoners to have some contact with friends and family while incarcerated, the justice system aims to facilitate their transition back into society upon release. Traditional forms of contact include telephone calls, in-person visitation, conjugal visits, etc. More recently, technological advances have allowed jails and prisons to provide other types of visitation, including videoconferences and online chat sessions.

To enable these various types of communications, a jail or prison may install or otherwise deploy communication and/or media access devices in different parts of the facility. Such communication and/or media access devices are generally used to enable inmate communications, but may also be used for other purposes.

### SUMMARY

Embodiments disclosed herein are directed to systems and methods for video visitation and calling using Rich Communication Services (RCS). In an illustrative, non-limiting embodiment, a method may include: receiving a text message, via a native RCS client of a non-resident device operated by a non-resident of a correctional facility, indicating that a scheduled video visitation session with a resident of the correctional facility is available to be established; and establishing the scheduled video visitation session between the resident and the non-resident, at least in part, via the native RCS client.

In various embodiments, the resident may participate in the scheduled video visitation session while operating a resident device that executes a native RCS client. The scheduled video visitation session may be established, at least in part, in response to a determination that the resident is eligible for using RCS.

For example, the determination may be based upon an identity of the resident. Additionally, or alternatively, the determination may be based upon an identity of the resident device. Additionally, or alternatively, the determination may be based upon an identity of the correctional facility. Additionally, or alternatively, the determination may be based upon a time of the scheduled video visitation session. Additionally, or alternatively, the determination may be based upon a physical location of the resident within the correctional facility.

In some cases, the resident may participate in the scheduled video visitation session while operating a resident device that executes a non-RCS client. The scheduled video visitation session may be established via a protocol translation operation, at least in part, in response to a determination that the resident is not eligible for using RCS. The determination may be based upon at least one of: an identity of the resident, an identity of the resident device, an identity of the correctional facility, a time of the scheduled video visitation session, or a physical location of the resident within the correctional facility.

In another illustrative, non-limiting embodiment, a computer system may include a processor and a memory coupled to the processor, the memory having program instructions stored thereon that, upon execution by the processor, cause the computer system to: transmit a text message, via a native RCS client of a resident device operated by a resident of a correctional facility, to initiate a video call with a non-resident of the correctional facility, and establish the video call between the resident and the non-resident, at least in part, via the native RCS client.

In yet another illustrative, non-limiting embodiment, a hardware memory device may have program instructions stored thereon that, upon execution by a processor of a computer system, cause the computer system to: receive an indication that a text message has been exchanged between a resident and a non-resident of a correctional facility using an RCS protocol, and facilitate a video communication between the resident and the non-resident using the RCS protocol based, at least in part, upon a determination that the resident is eligible for RCS-based video communications.

In various embodiments, one or more of the techniques described herein may be performed by one or more computer systems. In other various embodiments, a hardware memory device may have program instructions stored thereon that, upon execution by one or more computer systems, cause the one or more computer systems to execute one or more operations disclosed herein. In yet other various embodiments, a system may include at least one processor and memory coupled to the at least one processor, the memory configured to store program instructions executable by the at least one processor to cause the system to execute one or more operations disclosed herein.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale:

FIG. 1 is a diagram of an example of a system for video visitation and calling using Rich Communication Services (RCS) according to some embodiments.

FIG. 2 is a diagram of an example of a visitation system according to some embodiments.

FIG. 3 is a diagram of an example of a computer system according to some embodiments.

FIG. 4 is a screenshot of an example of a native RCS user interface according to some embodiments.

FIG. 5 is a flowchart of an example of a method for video visitation and/or calling using RCS according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. Also, any headings used herein are for organizational purposes only and are not intended to limit the scope of the description. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

Various types of controlled-environment facilities are used in today's society, and persons may be voluntary or involuntary residents of those facilities, whether temporarily or permanently. Examples of controlled-environment facilities include correctional institutions (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation facilities, such as drug and alcohol rehabilitation facilities, etc.), restricted living quarters (e.g., hotels, resorts, camps, dormitories, schools, barracks, etc.), and the like.

Systems and methods described herein may be applicable to any type of controlled-environment facility and its residents. For convenience of explanation, however, various examples herein are discussed in the context of correctional facilities. In some examples, a controlled-environment facility may be referred to as a correctional facility, jail, or prison, and its residents may be referred to as inmates, arrestees, or detainees.

Among other types of controlled-environment facilities, correctional facilities stand out in that it can still present numerous, unique difficulties in areas such as security, surveillance, financial transactions, communications, visitation, investigation, budgets, etc.; which in turn make technological implementations uniquely challenging in those environments. Often, technologies that are used outside of correctional facilities are not immediately applicable to the correctional environment without significant changes and modifications. Moreover, correctional facilities may have specific needs that are not particularly relevant outside of those environments. As such, some of the systems and methods described herein may be specifically tailored to address one or more of the aforementioned needs and challenges.

This specification relates generally to systems and methods for video visitation and calling using Rich Communication Services (RCS). In some applications, these systems and methods may be applied to any type of video communication involving residents and non-residents of controlled-environment facilities.

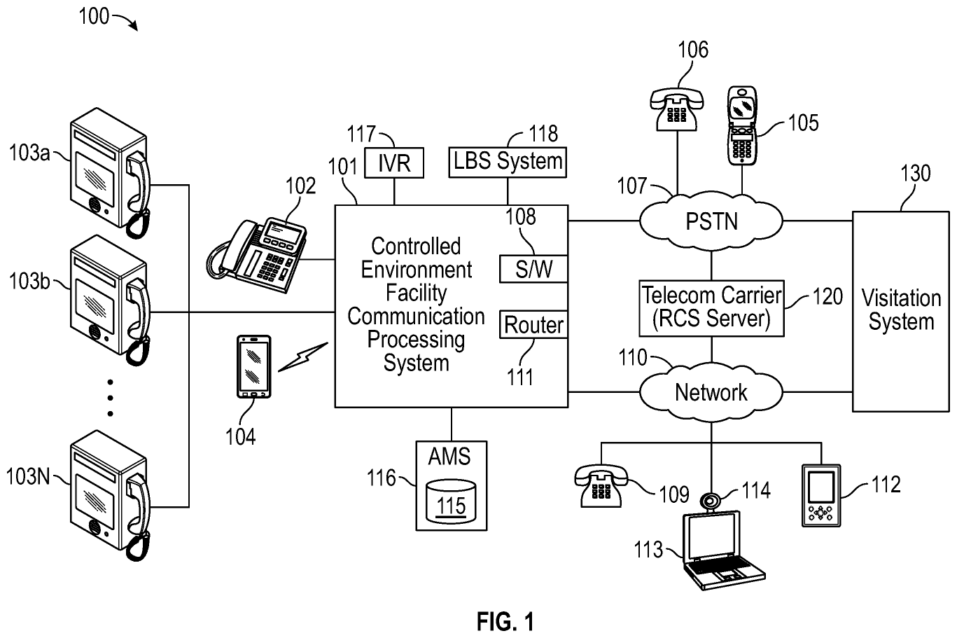

Turning now to FIG. 1, a block diagram of an example of a controlled-environment facility 100 is depicted according to some embodiments. As shown, communication processing system 101 provides telephone services, videoconferencing, online chat, email, and other communication services to controlled-environment facility 100 (e.g., a correctional facility).

In some cases, communication system 101 may be co-located with controlled-environment facility 100. Alternatively, communication system 101 may be centrally or remotely located with respect to one or more controlled-environment facilities and/or may provide communication services to multiple controlled-environment facilities. More generally, however, it should be noted that communication system 101 may assume a variety of forms, and may be configured to serve a variety of facilities and/or users, whether within or outside of controlled-environment facility 100.

In the context of a correctional facility, for instance, inmates may use telephones 102 to access certain communication services. In some cases, inmates may also use a personal computer wireless device 104 (e.g., a tablet or cell phone) to access such services. For example, an inmate may initiate telephone services by lifting the receiver on telephone 102, at which time the inmate may be prompted to provide a personal identification number (PIN), other identifying information or biometrics. An interactive voice response (IVR) unit 117 may generate and play prompt or other messages to inmates on devices 102 and/or 104.

Under the control of communication processing system 101, devices 102 and 104 may be capable of connecting to a non-resident's (i.e., a person not committed to a controlled-environment facility) device 105 or telephone 106 across Publicly Switched Telephone Network (PSTN) 107.

For example, device 105 may be a mobile phone, whereas telephone 106 may be located at a non-resident's home, inmate visitation center, etc. Switch 108 in communication processing system 101 may be used to connect video visitation sessions or calls across PSTN 107. Additionally, or alternatively, the non-resident may be at telephone 109 or device 112, which is on an Integrated Services Digital Network (ISDN), Voice-over-IP (VoIP), or packet data network 110, such as, for example the Internet. Router 111 of communication system 101 is used to route data packets associated with a video visitation session or call connection to destination telephone 109 or device 112.

Video visitation devices 103a-n (each collectively referred to as “video visitation device 103”) may have video conferencing capabilities to enable inmates to participate in video visitation sessions with non-residents of the correctional facility via video call, secure online chat, etc. For example, a non-resident party may have a personal or laptop computer 113 with camera 114 (or a cell phone, tablet computer, etc.). Additionally, or alternatively, device 112 may have an integrated camera and display (e.g., a smart phone, tablet, etc.).

A network connection between the parties may be established and supported by an organization or commercial service that provides computer services and software for use in telecommunications and/or VOIP, such as SKYPE®. Additionally, or alternatively, the correctional facility and/or the destination may use videoconferencing equipment compatible with ITU H.323, H.320, H.264, and/or V.80, or other suitable standards. Generally speaking, each video visitation device 103 may be disposed in a visitation room, in a pod, kiosk, etc.

In addition to providing certain visitation and communication operations, communication processing system 101 may attempt to ensure that an inmate's calls, video conferences, online chats, etc. are performed only with non-residents whose identities, devices, email addresses, phone numbers, etc. are listed in that inmate's Pre-Approved Contact (PAC) list. Each inmate's PAC list may be stored, for example, in database 115 maintained by Administration and Management System (AMS) 116.

In some embodiments, a PAC list may identify each person approved to communicate with a given inmate, as well as a relationship between that person and the inmate (e.g., friend, attorney, spouse, child, parent, cousin, uncle, aunt, etc.). In addition to PAC list(s), AMS 116 may also store inmate or Resident Profile Data or RDP (e.g., full name, date and place of birth, residence(s), etc.), as well as any visitation rules applicable to each inmate. Database 115 may also include other personal information about each inmate.

As an example, still in the context of a correctional facility, database 115 may include information such as balances for inmate trust and calling accounts; litigation and judicial hearing schedule; conviction data (e.g., indicating the gravity of a crime); past criminal record; sentencing data, time served, time remaining to be served, and release date; cell and cellmate assignments; inmate restrictions and warnings; commissary order history; video visitation history; video recordings; telephone call history; call recordings; known or suspected gang or criminal affiliations; known or suspected affiliates, accomplices, or gang members; and any other information that may be relevant or useful to correctional facility staff to house and maintain inmates.

For example, database 115 may include, for each inmate, one or more geographical zones of interest—e.g., places that likely contain evidence against the inmate or its accomplices. These zones may have boundaries arbitrarily drawn on a geographical map. Additionally, or alternatively, a zone of interest may be circular with a center (e.g., latitude and longitude, building, city, etc.) and a radius, or it may have other regular geometric shape (e.g., a square). Additionally, or alternatively, the geographical zone of interest may be a section of a road, street, or highway—suspected to be used as a criminal activity corridor (e.g., drug smuggling, human trafficking, etc.). Additionally, or alternatively, the geographical zone of interest may be a public transportation area (e.g., airport, bus station, train station, docks, etc.).

Generally speaking, database 115 may include any suitable type of application or data structure that may be configured as a data repository. For example, database 115 may be configured as one or more relational databases that include one or more tables of columns and rows and that may be searched or queried according to a query language, such SQL or the like. Alternatively, database 115 may be configured as structured data stores that include records formatted according to a markup language, such as XML or the like. In other embodiments, database 115 may be implemented using one or more arbitrarily or minimally structured files managed and accessible through a corresponding type of application.

Visitation system 130 may be configured to provide, schedule, and manage visitation services to residents and non-residents of a controlled-environment facility. To that end, visitation system 130 may be coupled to PSTN 107 and/or network 110 in a manner similar to communication processing system 101 by also including one or more gateways, switches and/or routers (not shown). Accordingly, visitation system 130 may be configured to communicate with one or more residents of the controlled-environment facility via devices 102-104 and with one or more non-residents via devices 105, 106, 109, 112, and/or 113. Although visitation system 130 is shown in FIG. 1 as being remotely located with respect to communication processing system 101 and the controlled-environment facility, in other cases visitation system 130 may be co-located with the facility and/or integrated within system 101.

In some implementations, communication system 101 may be configured to perform video visitation monitoring operations configured to monitor and or record video visitations (e.g., as electronic video files). In scenarios where communication system 101 is located within the controlled-environment facility, it may have direct access to AMS 116. In other embodiments, however, communication system 101 may be located remotely with respect to the controlled-environment facility, and access to AMS 116 may be obtained via a computer network such as, for example, network 110.

In some cases, communication system 101 may facilitate communications between communication devices via one or more telecommunication carriers or service providers 120, which may include their own proprietary network infrastructure. In some cases, carrier 120 may provide telecommunication services to devices 105, 106, 109, 112, and 114, including voice, data, and/or text. Within the carrier 120's network, a Rich Communication Service (RCS) server may provide RCS services, replacing Short Message Service (SMS) messages with a text-message system that is richer, providing features such as phonebook polling (e.g., for service discovery) and in-call multimedia.

For example, in various implementations, RCS users may be capable of sharing their location with each other, or attach high-resolution pictures, videos and audio to messages, using a native text application on their respective devices. Moreover, the RCS standard also supports video calls. RCS implements client-to-server encryption, and uses a data connection instead of carrier 120's signaling systems, so that messages can be sent or received via Wi-Fi (rather than cellular).

In some embodiments, video visitation devices 103 may be implemented as computer-based systems. For example, each of video visitation devices 103 may include a display, camera, and handset. The display may be any suitable electronic display such as, for example, a Liquid Crystal Display (LCD), a touchscreen display (e.g., resistive, capacitive, etc.), or the like, whereas the camera may be a suitable imaging device such as, for instance, a video camera or webcam equipped with Charge-Coupled Devices (CCDs), Complementary Metal-Oxide-Semiconductor (CMOS) active pixel sensors, etc. A handset may be similar to a traditional telephone handset including an earpiece portion (with a loudspeaker), a handle portion, and a mouthpiece portion (with a microphone).

During a video visitation session, video visitation devices 103 may be configured to capture a video image of an inmate to be transmitted to a non-resident using the camera, and to display a video image of the non-resident to the inmate using the display. Video visitation devices 103 may also be configured to capture an audio signal from the inmate to be transmitted to a non-resident using the mouthpiece portion of the handset, and to provide an audio signal from the non-resident to the inmate using the earpiece portion of the handset. Additionally, or alternatively, audio received from the non-resident may be reproduced via a loudspeaker, and audio provided by the inmate may be captured via a microphone.

In some cases, video visitation devices 103 may assume the form of any computer, tablet computer, smart phone, etc., or any other consumer device or appliance with videoconferencing capabilities.

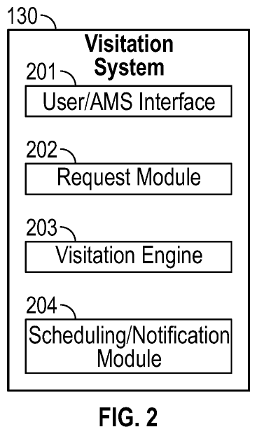

Referring to FIG. 2, a block diagram of visitation system 130 for providing visitation services to residents and non-residents of a controlled-environment facility is depicted according to some embodiments. As shown, visitation system 130 includes user and/or AMS interface 201. In some embodiments, residents and/or non-residents of one or more controlled-environment facilities may access, interact with, or otherwise use visitation system 130 via interface 201. For example, interface 201 may be provided as a web interface, IVR interface, or the like. Visitation system 130 may also interact with one or more AMS systems 116 either directly or via a computer network such as the Internet 110 using interface 201.

In some scenarios, a resident and/or non-resident may connect to visitation system 130 via interface 201. For example, the resident and/or non-resident may directly or indirectly (e.g., through an officer or personnel of the controlled-environment facility) reach a computer terminal or a telephone disposed within a controlled-environment facility and request visitation services. In other scenarios, the resident and/or non-resident may interact with interface 201 via PSTN 107 using an IVR system or the like. Additionally, or alternatively, the resident and/or non-resident may access interface 201 via a website, webpage, Internet portal, etc. via a computer network or Internet 110, for example, using a personal computing device (e.g., running a web browser), cell phone (e.g., via an “app”), prison terminal, or any other suitable client terminal or device.

When implemented to support web-based interactions, interface 201 may be deployed using a number of suitable techniques. For example, interface 201 may be implemented using Hypertext Markup Language (HTML), Common Gateway Interface (CGI), Javascript, PHP, Perl, C/C++, or any suitable combination of these or other commercial, open source and/or proprietary languages, frameworks or development environments for generating and distributing web-based information. Further, in some implementations, request and response data may be exchanged between a client and visitation system 130 through the use of messages or documents formatted in eXtensible Markup Language (XML) or other platform-independent data format.

For example, in some embodiments, a web services request to provide visitation services may be embodied in an XML document including fields identifying the person(s) that will be participating in the visitation, the type, time, and/or duration of the visitation, and possibly other fields, in which each field is delimited by an XML tag describing the type of data the field represents. In other implementations, web services-related documents may be transmitted between applications making requests and targeted web services using a web-based data transfer protocol, such as a version of the Hypertext Transfer Protocol (HTTP), for example.

In addition to interface 201, visitation system 130 includes visitation request module 202, visitation engine 203, and visitation scheduling/notification module 270. Visitation request module 202 may be configured to receive one or more visitation scheduling requests, modification requests, or cancellation requests, for example, via interface 201.

Visitation engine 203 may be configured to execute an incoming request, for example, by facilitating a voice, video, and/or electronic connection to take place between one or more residents and one or more non-residents.

Visitation scheduling/notification module 204 may be configured to schedule a new visitation and/or notify a relevant party (e.g., resident, non-resident, counselor, etc.) of the new visitation. Scheduling/notification module 204 may also be configured to modify a previously scheduled visitation and/or notify a relevant party of the modification, or cancel a scheduled visitation and/or notify a relevant party of the canceled visitation.

In some embodiments, visitation engine 203 may be configured to store a plurality of rules usable by request module 202 and/or scheduling/notification module 204 during the course of their respective operations. For example, visitation engine 203 may store one or more scheduling rules that allows (or prohibits) certain persons to perform a visitation scheduling operation. Those rules may be applied to incoming visitation requests by visitation request module 202. Also, engine 203 may include other rules regarding notifications or conflict resolution operations that may be employed by scheduling/notification module 204.

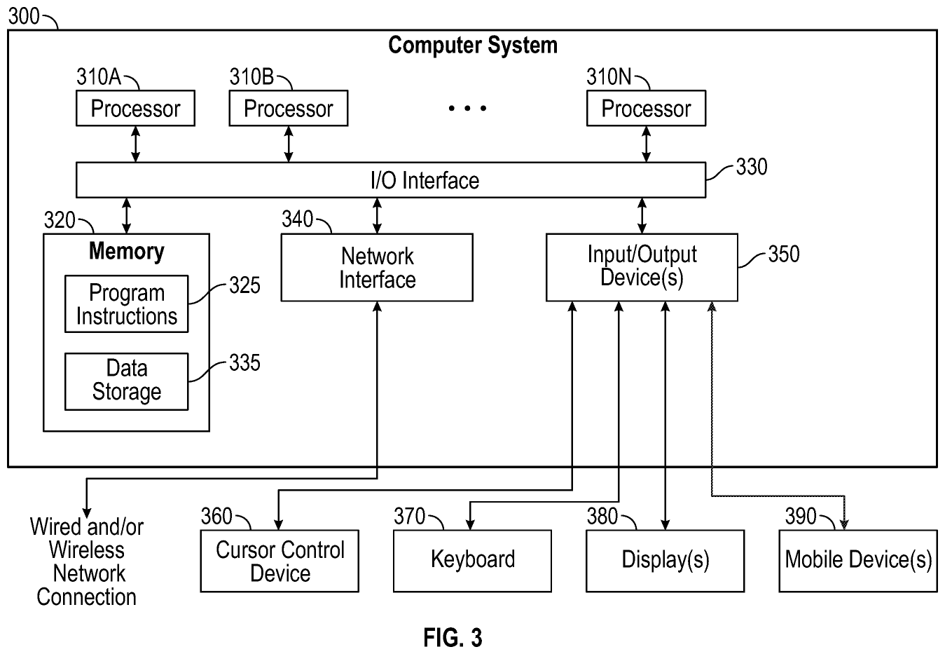

As noted above, embodiments of systems and methods described herein may be implemented using one or more computer systems, and one such system is illustrated in FIG. 3. System 300 may be a server, a workstation, a desktop computer, a laptop, a tablet computer, a mobile device, a smart phone, or the like.

In some cases, system 300 may be used to implement communication system 101, IVR 117, LBS system 118, and/or one or more communication devices. For example, devices 102-105, 112, and 113 may be implemented as dedicated processor-based, electronic devices similar to computer system 300. Additionally, or alternatively, these devices may be implemented as integrated components of computer system 300 (e.g., as part of a tablet computing device or the like).

Computer system 300 includes one or more processors 310A-N coupled to a system memory 320 via an input/output (I/O) interface 330. Computer system 300 further includes a network interface 340 coupled to I/O interface 330, and one or more input/output devices 350, such as cursor control device 360, keyboard 370, display(s) 380, or mobile device(s) 390. Other devices may include, for example, surveillance cameras, microphones, antennas/wireless transducers, phone detection modules, etc. In some embodiments, each of communication system 101, LBS system 118, visitation system 130 and/or one or more of devices 103-106 and 109-113 may be implemented using a single instance of computer system 300, while in other embodiments multiple such systems, or multiple nodes making up computer system 300, may be configured to host different portions of a given electronic device or system.

In various embodiments, computer system 300 may be a single-processor system including one processor 310, or a multi-processor system including two or more processors 310 (e.g., two, four, eight, or another suitable number). Processors 310 may be any processor capable of executing program instructions. For example, in various embodiments, processors 310 may be general-purpose or embedded processors implementing any of a variety of instruction set architectures (ISAs), such as the x86, PowerPC®, ARIVI®, SPARC®, or MIPS® ISAs, or any other suitable ISA. In multi-processor systems, each of processors 310 may commonly, but not necessarily, implement the same ISA. Also, in some embodiments, at least one processor 310 may be a graphics processing unit (GPU) or other dedicated graphics-rendering device.

System memory 320 may be configured to store program instructions and/or data accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described below in connection with FIGS. 6-12, may be stored within system memory 320 as program instructions 325 and data storage 335, respectively.

In other embodiments, program instructions and/or data may be received, sent or stored upon different types of computer-accessible media or on similar media separate from system memory 320 or computer system 300. Generally speaking, a computer-accessible medium may include any tangible storage media or memory media such as electronic, magnetic, or optical media—e.g., disk or CD/DVD-ROM coupled to computer system 300 via I/O interface 330. Program instructions and data stored on a tangible computer-accessible medium in non-transitory form may further be transmitted by transmission media or signals such as electrical, electromagnetic, or digital signals, which may be conveyed via a communication medium such as a network and/or a wireless link.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310).

In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. In addition, in some embodiments some or all of the functionality of I/O interface 330, such as an interface to system memory 320, may be incorporated directly into processor 310.

Network interface 340 may be configured to allow data to be exchanged between computer system 300 and other devices attached to a network, such as other computer systems, or between nodes of computer system 300. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touchpads, scanning devices, voice or optical recognition devices, mobile devices, or any other devices suitable for entering or retrieving data by one or more computer system 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

Memory 320 may include program instructions 325, configured to implement certain embodiments described herein, and data storage 335, comprising various data may be accessible by program instructions 325. In an embodiment, program instructions 325 may include software elements of embodiments illustrated in the above figures. For example, program instructions 325 may be implemented in various embodiments using any desired programming language, scripting language, or combination of programming languages and/or scripting languages (e.g., C, C++, C#, Java™, JavaScript™, Perl, etc.). Data storage 335 may include data that may be used in these embodiments (e.g., recorded communications, profiles for different modes of operations, etc.). In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

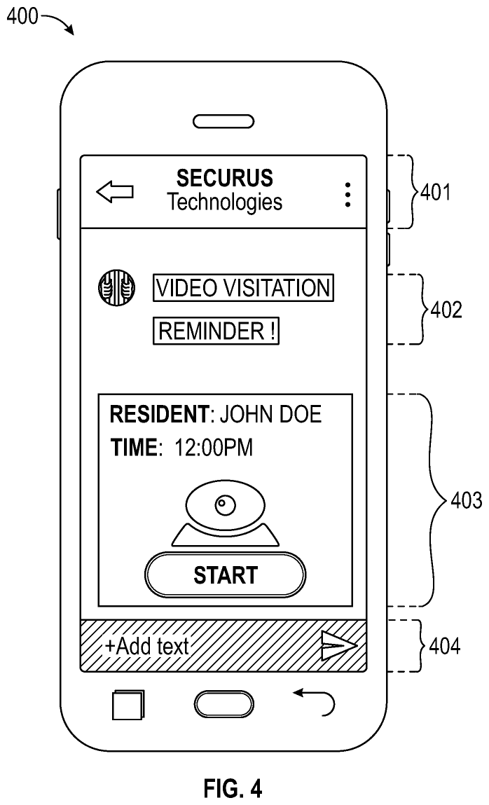

FIG. 4 is a screenshot of an example of a native RCS user interface 400. In some embodiments, native RCS user interface 400 may be displayed by any of the communications devices shown in FIG. 1. Generally, native RCS user interface 400 may be presented by a native texting application executed by the communication device, the layout of which can be carrier-dependent. A native texting application is presented herein in contradistinction with any third-party texting or communication application, which is not provided by the manufacturer of the communication device; but rather it is installed afterwards.

In this case, header portion 401 indicates an origin/destination or service providing or facilitating the video communication. Text portion 402 includes a text notification in cases when a video visitation session that has been previously scheduled and is ready to start. Active portion 403 may include an identification of the party to the video visitation (e.g., an inmate's name), a scheduled time of the visitation, and an active or interactive control (e.g., a graphical button) that allows the user of interface 400 to have a video visitation, video conference, or any video-based communication with the party identified—all without closing native RCS user interface 400, and without otherwise leaving the native RCS application. Portion 404 is a bar where the user can enter text to be sent over RCS, potentially during the same video communication.

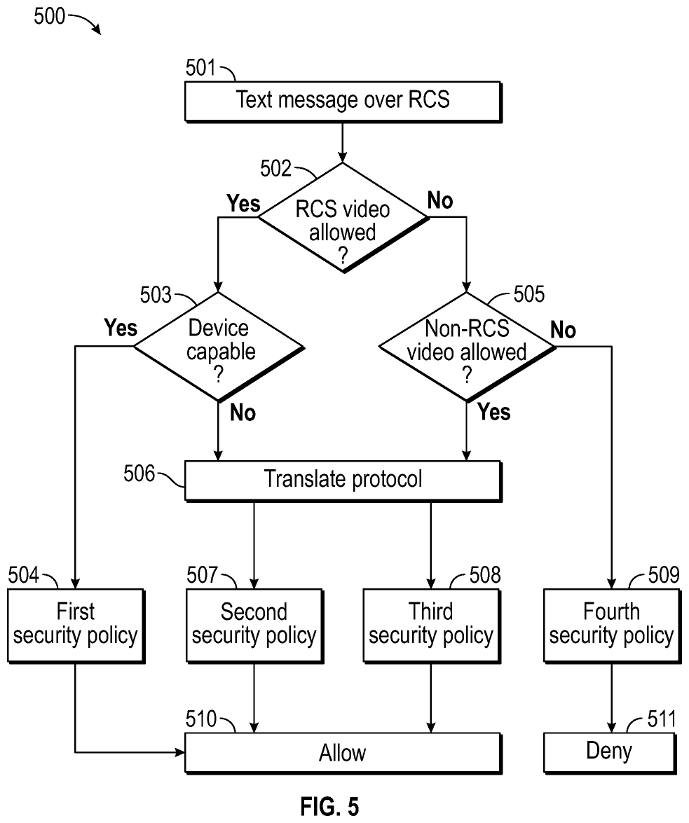

FIG. 5 is a flowchart of an example of a method for video visitation and/or calling using RCS according to some embodiments. At block 501, an RCS text message may be received, transmitted, or exchanged over an RCS protocol or connection. For example, the RCS text message may be shown in text portion 402 of native RCS interface 400.

In some cases, the RCS text message of block 501 may be initiated by a resident of a correctional facility in the form of an on-demand, resident-initiated video call request, over an RCS protocol, connection, or communication. In other cases, the RCS text message may be initiated by a non-resident in the form of an on-demand, non-resident-initiated video call request, over an RCS protocol, connection, or communication.

In various implementations, the RCS text message of block 501 may be initiated by visitation system 130 and/or controlled-environment facility communication processing system 101. For example, in the case of a previously scheduled video visitation session, the visitation may have been scheduled by a non-resident in advance. At a later time—that is, at or near the scheduled time—a text message may be sent, over RCS, to a resident's and/or a non-resident's device with an alert that the video visitation is ready to begin.

At block 502, method 500 determines whether RCS video is allowed to proceed for the video visitation or call. If so, block 503 determines whether the communication device of the resident or the non-resident is natively RCS-capable. If, so a first security policy may be applied to the video communication, which is then allowed to proceed at block 510.

Returning to block 503, if the communication device of the resident or the non-resident is not natively RCS-capable, block 506 performs a protocol translation operation. In this case, block 506 may convert RCS content (e.g., a video feed) into another format suitable for transmission to a third-party video conferencing application that can be executed by that communication device. Then, block 510 again allows the video communication to proceed upon application of a second security policy at block 507.

If block 502 determines that RCS video is not allowed, block 505 determines whether any non-RCS video communication is allowed. If so, block 506 converts RCS content (e.g., a video feed) into another format suitable for transmission to a third-party video conferencing application that can be executed by that communication device upon application of a third security policy at block 508. Otherwise, block 509 applies a fourth security policy 509, and block 511 denies the video communication.

In some cases, the determination of whether RCS video is allowed may be made based upon the identity of the resident, or based upon any other incarceration information associated with the resident and stored in AMS 116. Additionally, or alternatively, the determination of whether RCS video is allowed may be made based on the identity of the non-resident. For example, certain persons, residents and/or non-residents, may have RCS privileges or clearance to conduct RCS video communications, and others may not.

Additionally, or alternatively, the determination of whether RCS video is allowed may be made based upon the identity or type of resident device. For instance, communication device or tablet 104 may be allowed to use RCS video, whereas video visitation device 103 may not be RCS-capable. Instead, video visitation 103 may offer a third-party non-RCS video conferencing application or the like.

Additionally, or alternatively, the determination of whether RCS video is allowed may be made based upon the identity of the correctional facility where the resident is located. For example, some correctional facilities may allow RCS video visitations or calling involving residents, and others may not. Additionally, or alternatively, the determination of whether RCS video is allowed may be made based upon the time of the scheduled video visitation session. For example, there may be only specific times of the day, or days of the week, when RCS video visitation or calling involving residents is allowed. Additionally, or alternatively, the determination of whether RCS video is allowed may be made based upon a physical location of the resident within the correctional facility. For example, there may be certain physical locations within a correctional facility (e.g., a cell, wing, commissary area, recreational area, cafeteria, visitation room, etc.) from which video calls are allowed, and other locations from which it may not be allowed.

In various embodiments, any combination of the foregoing features may be used to determine whether RCS video is allowed for a particular call, or video visitation, for instance, in response to the exchange of an RCS text message announcement or alert. As such, depending upon any selected combinations of various factors, a controlled-environment facility may apply a distinct security policy or protocol to the video communication, in real-time.

In the example of FIG. 5, when RCS video is allowed, a first policy is applied when the resident's device is RCS-capable, and a second policy is applied when the resident's device uses a non-native application that requires protocol translation. When RCS video is not allowed, a third security policy is applied when non-RCS video is allowed instead, and a fourth security policy is activated when the video communication is altogether denied.

In some cases, the first policy may have more restrictive features than the second policy, the second policy may be more restrictive than the third security policy, and the fourth security policy may be the most restrictive. For example, the first security policy may impose a first time limit (e.g., a maximum duration) for the video visitation, the second security policy may impose a second time limit longer than the first time limit, and the third security policy may impose a third time limit longer than the second time limit.

In some cases, the first policy may have less restrictive features than the second policy, the second policy may be less restrictive than the third security policy, and the fourth security policy may be the least restrictive. For example, the first security policy may impose a first time limit (e.g., a maximum duration) for the video visitation, the second security policy may impose a second time limit shorter than the first time limit, and the third security policy may impose a third time limit shorter than the second time limit.

Examples of other restrictions that can be imposed by the various security policies of blocks 504, 507, 508, and/or 509 include, but are not limited to: whether or not to record the video communication, whether to apply an automatic screening process to the video communication, whether to introduce live monitoring into an ongoing video communication, whether to flag the video communication for investigative analysis, etc.

The various systems and methods illustrated in the figures and described herein represent example embodiments of systems and methods for systems and methods for querying location information from mobile communications devices. These techniques may be implemented in software, hardware, or a combination thereof. The order in which each operation of a given method is performed may be changed, and various elements of the systems illustrated herein may be added, reordered, combined, omitted, modified, etc. Various modifications and changes may be made as would be clear to a person of ordinary skill in the art having the benefit of this specification. It is intended that the invention(s) described herein embrace all such modifications and changes and, accordingly, the above description should be regarded in an illustrative rather than a restrictive sense.

1. A method, comprising:
receiving a text message, via a native Rich Communication Services (RCS) client of a non-resident device operated by a non-resident of a correctional facility, indicating that a scheduled video visitation session with a resident of the correctional facility is available to be established, wherein the native RCS client is provided by a manufacturer of the non-resident device; and
establishing the scheduled video visitation session between the resident and the non-resident, at least in part, via the native RCS client, wherein the scheduled video visitation session is established, at least in part, in response to a determination that the resident is eligible for using RCS.

2. The method of claim 1, wherein the resident participates in the scheduled video visitation session while operating a resident device that executes an RCS client, and wherein the video visitation session is conducted according to a first security policy.

3. The method of claim 2, wherein the determination of RCS eligibility is based on visitation rules applicable to the resident.

4. The method of claim 1, wherein the determination of RCS eligibility is based upon an identity of the resident.

5. The method of claim 1, wherein the determination of RCS eligibility is based upon an identity of the resident device.

6. The method of claim 1, wherein the determination is of RCS eligibility based upon an identity of the correctional facility.

7. The method of claim 1, wherein the determination of RCS eligibility is based upon a time of the scheduled video visitation session.

8. The method of claim 1, wherein the determination of RCS eligibility is based upon a physical location of the resident within the correctional facility.

9. The method of claim 1, wherein the resident participates in the scheduled video visitation session while operating a resident device that executes a non-RCS client, and wherein the video visitation session is conducted according to a second security policy.

10. The method of claim 9, wherein the scheduled video visitation session is established via a protocol translation operation configured to convert RCS content from the non-resident device to a format supported by the resident device.

11. The method of claim 10, wherein the scheduled video visitation session is established in response to a determination that the non-resident is eligible for using RCS based upon an identity of the non-resident.

12. A computer system, comprising:
a processor; and
a memory coupled to the processor, the memory having program instructions stored thereon that, upon execution by the processor, cause the computer system to:
transmit a text message, via a native Rich Communication Services (RCS) client of a resident device operated by a resident of a correctional facility, to initiate a video call with a non-resident of the correctional facility utilizing a non-resident device comprising a native RCS client provided by a manufacturer of the non-resident device; and
establish the video call between the resident and the non-resident, at least in part, via the native RCS client, wherein the video call is established, at least in part, in response to a determination that the resident is eligible for using RCS.

13. The computer system of claim 12, wherein the non-resident participates in the video call while operating the native RCS client of the non-resident device, and wherein the video call is conducted according to a first security policy.

14. The computer system of claim 13, wherein the video call is established, at least in part, in response to a determination that the non-resident is eligible for using RCS.

15. The computer system of claim 14, wherein the determination is based upon at least one of: an identity of the non-resident, an identity of the non-resident device, or a physical location of the non-resident outside the correctional facility.

16. The computer system of claim 12, wherein the non-resident participates in the video call while operating a non-resident device that executes a non-RCS client, and wherein the video call is established, at least in part, in response to a determination that the non-resident is eligible for using RCS, and wherein the video call is conducted according to a second security policy.

17. A hardware memory device having program instructions stored thereon that, upon execution by a processor of a computer system, cause the computer system to:
receive an indication that a text message has been exchanged between a resident and a non-resident of a correctional facility via a native Rich Communication Services (RCS) protocol client of a non-resident device operated by the non-resident, wherein the native RCS client is provided by a manufacturer of the non-resident device; and
facilitate a video communication between the resident and the non-resident using the RCS protocol based, at least in part, upon a determination that the resident is eligible for RCS-based video communications, wherein the video communication is facilitated, at least in part, in response to a determination that the resident is eligible for using RCS.

18. The hardware memory device of claim 17, wherein the determination is based upon at least one of: an identity of the resident, an identity of the resident device, an identity of the correctional facility, a time of the scheduled video visitation session, or a physical location of the resident within the correctional facility.

19. The hardware memory device of claim 18, wherein the program instructions, upon execution, further cause the computer system to facilitate the video communication based, at least in part, upon a determination that the non-resident is eligible for RCS-based video communications.

20. The hardware memory device of claim 19, wherein the determination is based upon at least one of: an identity of the non-resident, an identity of the non-resident device, or a physical location of the non-resident outside the correctional facility.
